(19) United States
(12) Patent Application Publication
(10) Pub. No.: US 2007/0241217 A1
(43) Pub. Date: Oct. 18, 2007

(54) Shredder guard child safety shield

(76) Inventor: Dennis L. Bolka, Michigan City, IN (US)

Correspondence Address: DENNIS L. BOLKA, 528 DUPAGE ST., MICHIGAN CITY, IN, 46360, US

(21) Appl. No.: 11/405,919

(22) Filed: Apr. 17, 2006

(51) Int. Cl. B02C 23/00

(52) U.S. Cl. 241/37.5

(57) ABSTRACT

Shredder Guard Child Safety Shield was designed to allow for additional height before paper enters cutter area of various brands and manufactures of the product know as paper shredder crosscut or strip type. This feature is necessary to insure an addition in height so Childs fingers or hand are not pulled into insertion area resulting in injury from shredder blades. A guard made of clear plastic material semi ridged in flexibility having a flanged bottom for mounting to existing paper shredders and to be high enough as to not allow Childs fingers or hand to be pulled into cutter or sometimes referred to as shredder blades. The clear plastic construction material will also allow for easy view of objects not wanted entering feed area resulting in damage to shredder.

Shredder Guard is designed to attach to top portion of the average size personal home paper shredder witch accepts eight and one-half inch wide sheets of paper. It consists of a clear plastic composite to allow for full view of objects entering shredder feed area. It will attach to top of your existing paper shredder with double faced tape and will have holes in lower flange area near ends to add screws for stability if required. It was designed to protect Childs fingers and hand from being pulled into cutter heads and prevent from injury as a result of.

### SPECIFICATIONS: (SHREDDER GUARD CHILD SAFETY SHIELD)

The invention consists of a clear transparent plastic material a proximally one-sixteenth inch in thickness and ten and one-half inches in length three inches in width and two and one-half inches at lower flange.

Lower flange area at the bottom that will attach to the top of any model paper shredder with a top surface that measures at least ten and one-half inches in width.

Above the lower flanged area is an upper raised area with radius corners with a width of two inches at base of flange and a width of one inch at upper portion of feed area.

Feed area will have a eight and three-quarters inch long by three-eights inch in width opening protruding down the center to bottom flange surface with a eight and three-quarters inch long by one-half inch width at bottom referred to as the feed tube.

The center paper feed tube will be reinforced on both sides with three ribs that are molded from feed tube wall to inner wall of outer surface with a thickness sufficient enough to allow stability and will protrude from bottom flange to inner most upper surface.

The flange surface will be smooth at bottom flange to allow for proper adhesion with double-faced tape to secure GUARD to paper shredder housing.

### DRAWINGS

BRIEF DESCRIPTION OF DRAWINGS: The present invention will be understood and appreciated more fully from the flowing detailed description taken in conjunction with the drawings in which:

FIG. 1 is a simplified perspective-view showing as to its dimensions and position when attached.

FIGS. 2 and 3 is a simplified side-view and end-view as to invention known as guard.

FIGS. 4 and 5 is a simplified top-view and bottom-view as to invention known as guard.

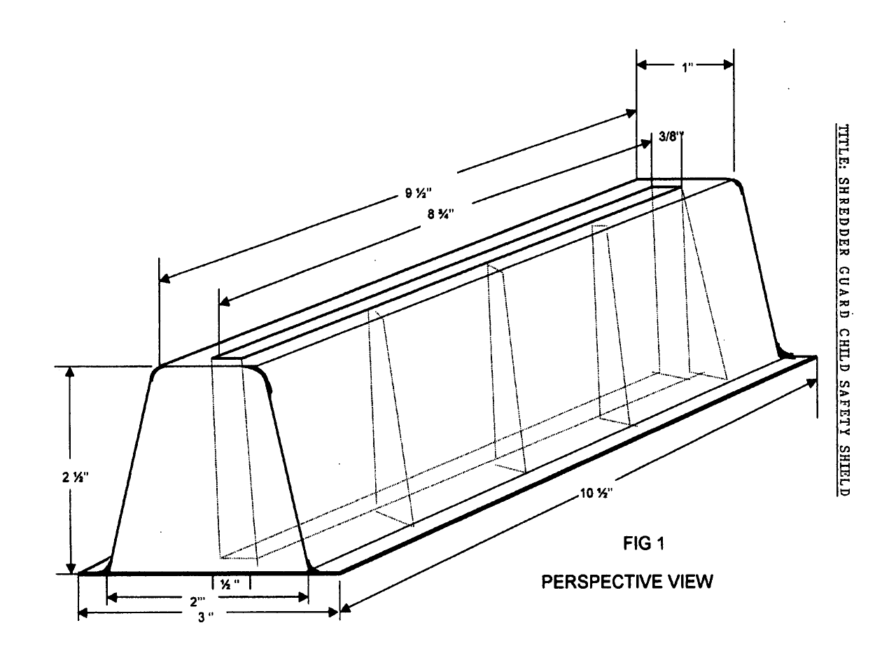

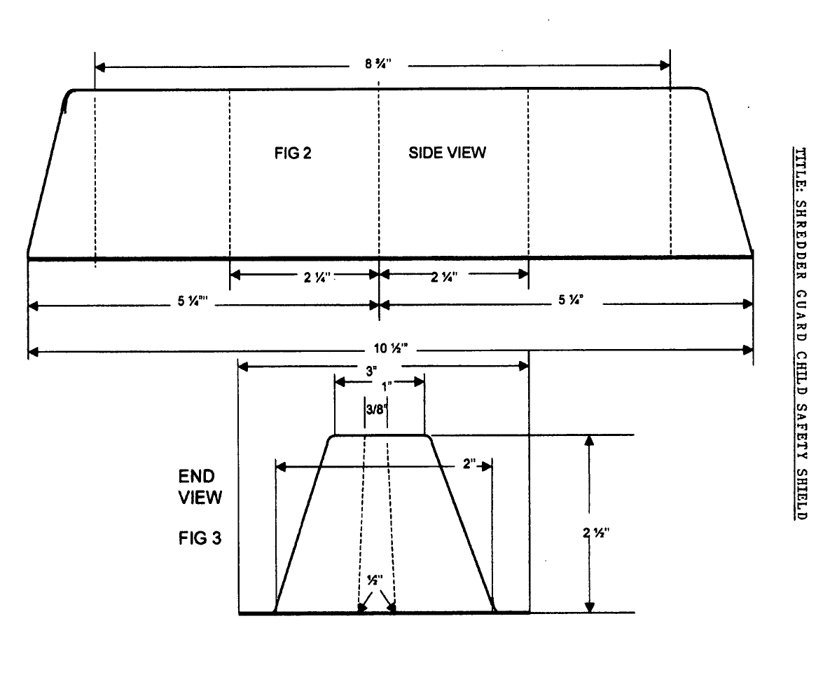

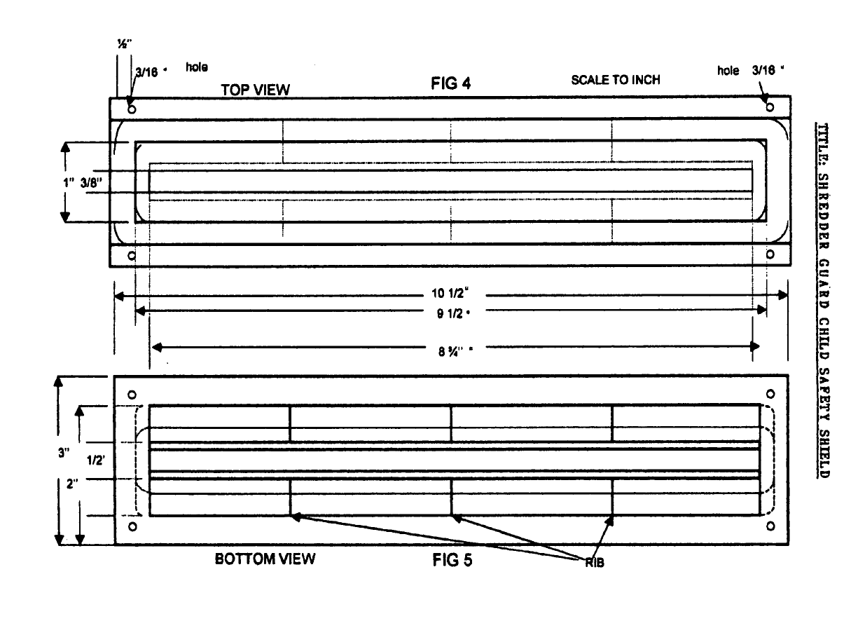

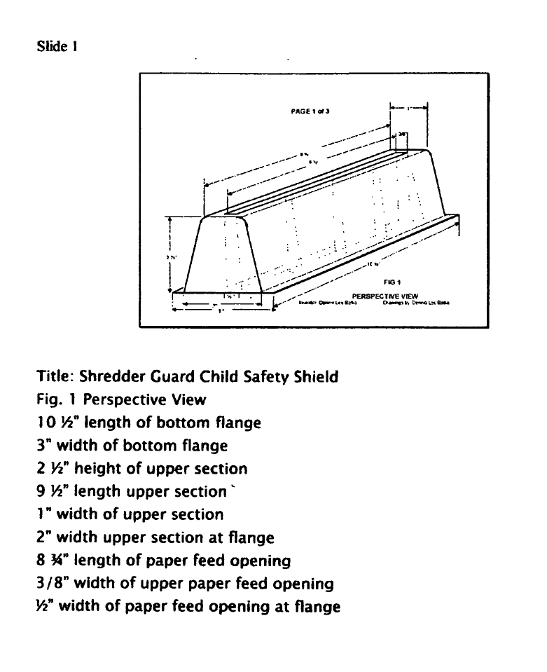

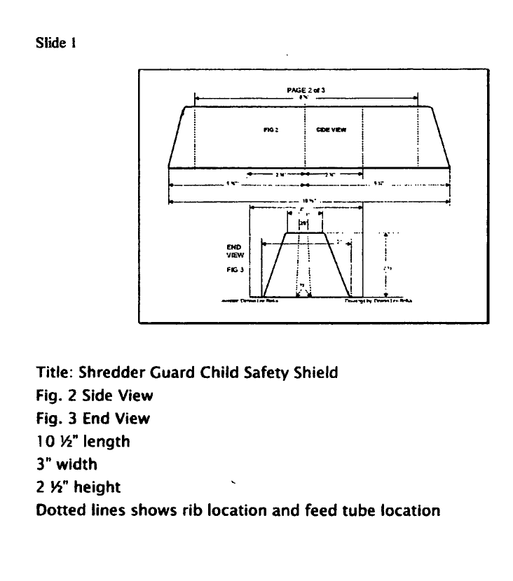

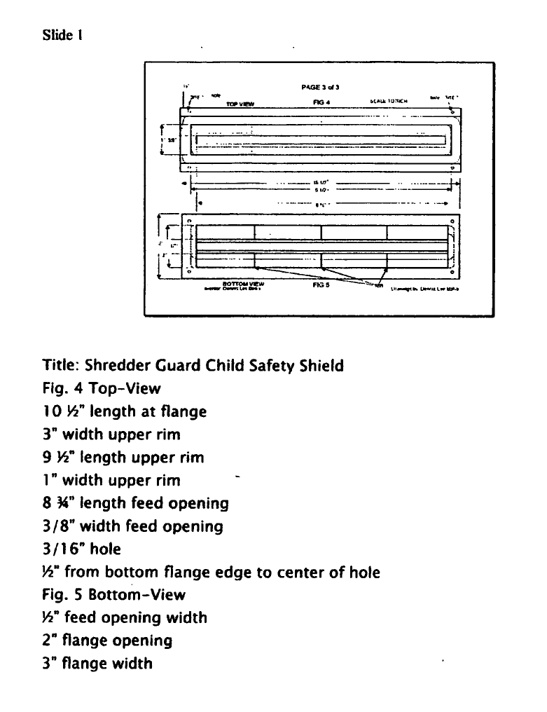

What is claimed is:

1. A safety device known as guard for paper shredders having a top feed device to accept paper no wider than eight and one-half inches in width and not limited to length witch shreds paper in cross-cut or strip method.

2. Said guard is designed to extend the height of the area known as paper feed entrance as to allow Childs fingers not to be pulled into cutter blades.

3. A safety device attachment for paper shredders known as guard in reference to drawings and Child Safety feature protection resulting in injury there of.

4. The safety device of claim 2 as to extension of height of guard to perform the safety feature intended of said attachment known as guard.
